(19) United States
(12) Patent Application Publication
(10) Pub. No.: US 2026/0272219 A1
(43) Pub. Date: Sep. 17, 2026

(54) HIGH EFFICIENCY AIR FRYER SYSTEM FOR COOKING CAVITY APPLIANCES

(71) Applicant: WHIRLPOOL CORPORATION, Benton Harbor, MI (US)

(72) Inventors: Lucas Baldani, Joinville (BR); Eduardo Martins, Joinville (BR); Marcelo Dorigon, Joinville (BR); Yogesh V. Sonone, Pune (IN); Taylor Sobjak, Joinville (BR); Peggy Romero, Joinvlle (BR)

(21) Appl. No.: 19/081,418

(22) Filed: Mar. 17, 2025

(51) Int. Cl. A47J 37/06; A47J 27/00; F24C 7/04; F24C 7/06; F24C 15/32

(52) U.S. Cl. CPC A47J 37/0641; A47J 27/004; F24C 7/046; F24C 7/067; F24C 15/325

(57) ABSTRACT

A cooking appliance having an air fry feature may include a cavity, an upper heating element and fan assembly placed at a top of the cavity, a lower heating element arranged at a bottom of the cavity, and an air fryer basket configured to rest over the lower heating element and below the upper element such that when food is placed in the air fryer basket, the food receives radiation from the lower heating element as well as hot air moved by the fan assembly.

### TECHNICAL FIELD

Disclosed herein are air fryer systems for cooking cavity appliances.

### BACKGROUND

Conventional air fryer appliances may include a basket and a heating element. These appliances typically draw external air into a cavity and then heat the air with a heating element. However, oftentimes, air does not efficiently flow within the cavity to maximize heating of the food within the basket.

### SUMMARY

A cooking appliance having an air fry feature may include a cavity, an upper heating element and fan assembly placed at a top of the cavity, a lower heating element arranged at a bottom of the cavity, and an air fryer basket configured to rest over the lower heating element and below the upper element such that when food is placed in the air fryer basket, the food receives radiation from the lower heating element as well as hot air moved by the fan assembly

An air fryer may include a cavity housing a basket to receive food a coil element arranged at a top of the cavity and configured to provide radiant heat to the basket, a heating element arranged at a bottom of the cavity to provide hot air from below the basket, and a fan assembly arranged at the top of the cavity and configured to move hot air from the coil element towards the basket.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompanying drawings in which:

FIG. 1 illustrates an example front view of a cooking appliance configured to perform cooking cycles.

FIG. 2 illustrates a front perspective view of the cooking appliance of FIG. 1.

FIG. 3 illustrates an exploded perspective view of the cavity top, fan assembly, deflector and coil element of FIGS. 1 and 2.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

Many air fryer design solutions for cooking appliances have a bake element arranged at the bottom of a cavity, a broil element arranged at the top, and a fan motor assembly composed of a ring element (in some cases) surrounding the fan motor assembly (to heat the air) and a blade to move the air in the back of the cavity. When food is placed inside the air fryer basket, the food is arranged over a cooking rack in the cavity.

In such a design, the food inside the air fryer basket is exposed to the broil and bake element radiation, but not also to the hot air flow outlet coming from the fan motor assembly. Because the hot air created by the fan motor assembly is not directly in line with the food, convective heat transfer may not occur. This results in poorer performance compared to conventional countertop air fryers in the market, as the heat source and air flow distribution are not effectively directed to the food. This reduced performance may result in approximately double the time required to prepare the same amount of food and/or additional energy usage.

Disclosed herein is a cooking appliance having a coil element arranged at or near a fan assembly. The fan assembly may be configured to receive air circulating from a baking element arranged below an air basket. The fan may draw air up through the cavity for recirculation.

The coil element is placed at the cavity top along with a bake element placed at the bottom. The fan motor assembly is placed on the top of the cavity. The food is placed inside the air fryer basket which sits over the rack. Because of this arrangement, the food placed inside the air fryer basket is exposed to the radiation from the coil element as well as to the hot air outlet exiting the fan motor assembly. The air directed by the fan motor assembly exchanges heat with the coil element and then is directed towards the air fryer basket. This design leads to a faster convection heat transfer.

The coil element includes circular spiral to cover a larger space to facilitate a more uniform heat distribution. The air deflector is used to drive the hot air directly to the food, and to mitigate pressure drop, resulting in higher cooking efficiency.

With this system having a convection fan motor assembly on the top of the cavity combined with the coil element, the cooking time to complete the air fryer cycle is significantly reduced. In some examples, the cooking time was reduced by approximately half the cycle time compared to cooking cavity appliances, air fryer systems, and conventional countertop air fryers. Further, the air driven by the fan motor assembly is received from inside the cavity environment, creating a recirculation vortex resulting in better efficiency due to less energy consumption required, different from countertop air fryers where the air comes from the external environment requiring more energy to increase its temperature to appropriate levels to provide air fryer effect.

The air deflector is designed to enclose the coil element. This provides a significant increase of efficiency due to the fact the radiation energy to cook the food coming from the coil element is contained within the coverage area of the air deflector towards the food in the air fryer basket right below.

The fan blades from the motor assembly are protected from access due to the enclosure created by air deflector. In an example, the gap between the coil element and the blade is less than 7 mm. Such deflector avoids the necessity of an extra sheet metal barrier.

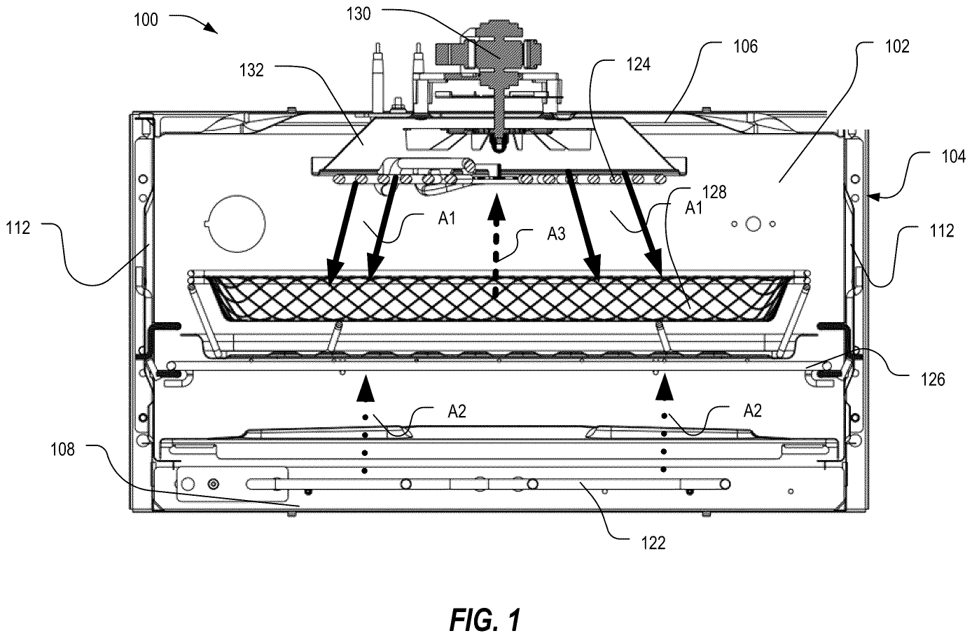

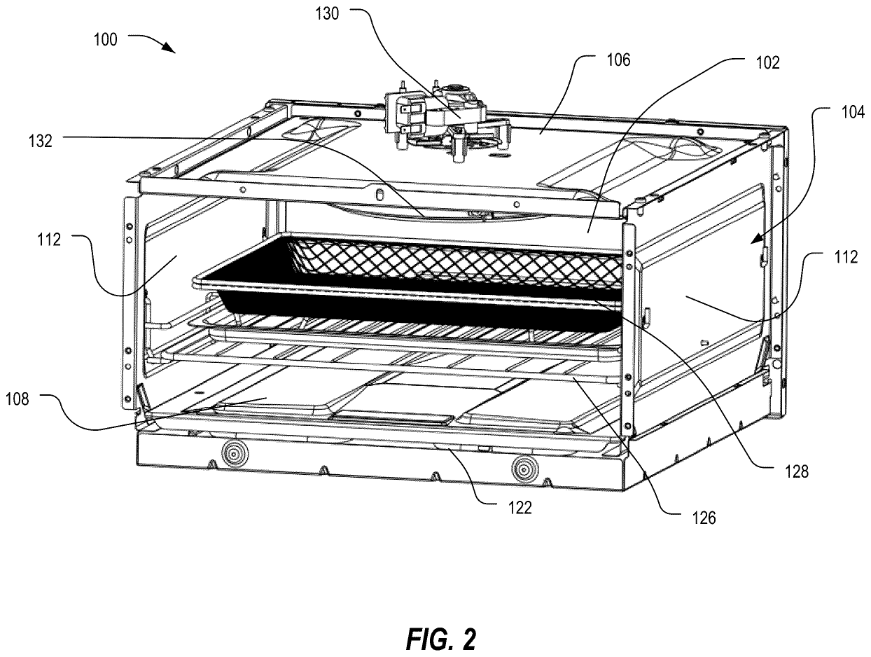

FIG. 1 illustrates an example front view of a cooking appliance 100 configured to perform cooking cycles. FIG. 2 illustrates a front perspective view of the cooking appliance 100. The cooking appliance 100 may be one of various cooking appliances, such as a conventional oven, a convection oven, a conduction oven, a microwave oven, a toaster oven, air fryer, etc. In some examples, the cooking appliance 100 may be a function-specific oven, such as a roaster oven, a pizza oven, etc. The cooking appliance 100 may be a standalone oven in some cases, while in other cases the oven may be built-in or a component of a combination oven and stove top. In yet another example, the cooking appliance 100 is a countertop appliance.

The cooking appliance 100 may form a cabinet 104 and define a cavity 102 having a cavity top 106, cavity bottom 108, cavity back (not specifically labeled), and side walls 112. A door assembly may be hinged at a front of the cavity bottom 108 to permit access to the cavity 102. Although not shown, the door assembly may include a window and a handle and may hermetically seal the cavity when the door is in a closed position. It should be noted that this is an example, and cooking appliance 100 with different types of doors may be used. For instance, a door may be hinged at a side instead of the bottom. A door sensor may be arranged on the door or the cavity 102 to detect an open and closed position of the door of the door assembly 120.

The cavity 102 may be configured to receive food items for cooking, baking, and/or broiling during a cooking cycle. The cavity 102 may also include temperature sensors 116 for determining the air temperature within the cavity 102 during cooking. The cooking appliance 100 may further include a user interface configured to receive user input with respect to cycles or other oven operation. The user interface may also provide information to the user such as cook time, temperature, etc.

The cooking appliance 100 may include a baking element 122 for heating the cavity 102 during cooking. The baking element 122 may include one or more heating elements, such as a gas heating element or an electric heating element. The baking element 122 is arranged at the bottom of the cavity 102. The baking element 122 may radiate heat upwards from the bottom of the cavity 102.

The cooking appliance 100 may include one or more racks 126 within the cavity 102 for supporting the food items during cooking. The cooking appliance 100 may also include a basket, such as an air fryer basket 128. As shown by way of example in FIGS. 1 and 2, the cooking appliance 100 may include one rack and one basket. It should be noted the more or fewer racks and baskets are possible. Regardless of quantity, the rack 126 and basket 128 may rest on side rails arranged along the side walls 112.

The side rails may extend parallel or generally parallel with the cavity top 106 and cavity bottom 108 along the side walls 112 at spaced intervals. The side rails may extend up the height of the side walls 112 to allow for varying positions of the racks 126 within the cavity 102. For each side rail arranged on the first side wall 112, a corresponding side rail is arranged on the opposite second side wall 112 (generally at the same relative height) so that the rack 126 and basket 128 may be evenly maintained on each side thereof. Food may be placed in the basket 128 for cooking as well as on the rack 126. The basket 128 may define a rectangular structure constructed from a wire mesh to facilitate airflow and drainage.

A coil element 124 is arranged at the top of the cavity 102. In other examples, heating elements may be arranged between the cabinet 104 and the cavity back 110 and/or the cavity top 106. The coil 124 may generate radiation and may cover a large diameter of the cavity top 106. A fan assembly 130 may be arranged at the cavity top 106. The fan assembly may be a convection fan and may output hot air. The air coming from the fan assembly 130 may exchange heat with the coil element 124, which is then directed towards the food in the basket 124. This may speed up the convention heat transfer.

An air deflector 132 may be arranged at the coil element 124 and configured to drive or guide the hot air directly to the food in the basket 128. The deflector 132 may enclose the coil element 124 by creating a funnel or conical shape around it to direct the air downward to the basket 128. The deflector 132 may define an opening at its center or apex to receive a shaft from at least the fan assembly 130. The deflector 132 may form a lip at its external diameter, such as a flange. The deflector 132 may be a shallow circular dish, frustrum, or cone. The deflector 132 may attach to the cavity top 106 via one or more attachment mechanisms.

In one example, the air deflector 132 may create a recirculation vortex with the air from the fan assembly 130, resulting in more efficiency, less energy consuming cooking process. Unlike traditional countertop air fryers, heated air is recirculated from within the cavity, and not drawn from an external environment which would require the temperature of the incoming air to be increased. The design of the air deflector 132 may also mitigate pressure drop, thus maximizing the speed of the hot air from the fan assembly 130 and the coil element 124, resulting in higher cooking efficiency.

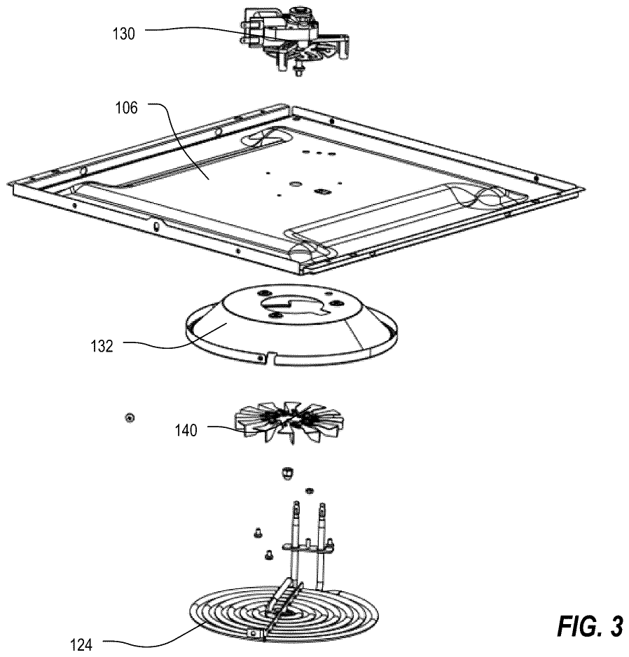

FIG. 3 illustrates an exploded perspective view of the cavity top 106, fan assembly 130, deflector 132 and coil element 124. As illustrated, the coil element 124 may form a circular shape and be arranged within the deflector 132. The air deflector 132 may also form a barrier around the fan blades 140. The deflector 132 avoids the additional costs required of an extra sheet metal barrier to mitigate additional air flow pressure drop and guards for the blades 140. The fan blades 140 are arranged between the coil element 124 and the deflector 132 to force heated air down towards the basket 128.

Returning to FIG. 1, hot air flow A1 may be generated by the coil element 124 and fan assembly 130 and pushed downward toward the basket 128. Concurrently, heated air A2 from the baking element 122 rises towards the underside of the basket 128. Cooler air A3 may return towards the fan assembly 130 to be reheated and recirculated to the basket 128 via the coil element 124 and fan assembly 130 (e.g., hot air flow A1.) Thus, recirculation allows for faster cook times, and higher efficiency.

In addition to the increased efficiency created by the recirculation, lower noise levels may be appreciated compared to conventional countertop air fryers. This may be due in part to lower fan motor speeds.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

The flowcharts and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A cooking appliance having an air fry feature, comprising:
a cavity;
an upper heating element and fan assembly placed at a top of the cavity;
a lower heating element arranged at a bottom of the cavity,
an air fryer basket configured to rest over the lower heating element and below the upper element such that when food is placed in the air fryer basket, the food receives radiation from the lower heating element as well as hot air moved by the fan assembly.

2. The cooking appliance of claim 1, where the coil element includes a circular spiral to produce uniform heat distribution.

3. The cooking appliance of claim 1, further comprising an air deflector arranged around at least a portion of the upper heating element to drive the hot air toward the air fryer basket.

4. The cooking appliance of claim 3, wherein the air deflector creates a conical shape around the upper heating element.

5. The cooking appliance of claim 4, where the fan assembly is arranged at least in part, external to the cavity.

6. The cooking appliance of claim 5, wherein at least one blade of the fan assembly is arranged within the cavity above the upper heating element.

7. The cooking appliance of claim 6, wherein the at least one blade is arranged within the air deflector.

8. The cooking appliance of claim 1, where the fan assembly creates a recirculation vortex by circulating air from inside the cavity.

9. An air fryer, comprising:
a cavity housing a basket to receive food;
a coil element arranged at a top of the cavity and configured to provide radiant heat to the basket;
a heating element arranged at a bottom of the cavity to provide hot air from below the basket; and
a fan assembly arranged at the top of the cavity and configured to move hot air from the coil element towards the basket.

10. The air fryer of claim 9, where the coil element includes a circular spiral to produce uniform heat distribution.

11. The air fryer of claim 9, further comprising an air deflector arranged around at least a portion of the coil element to drive the hot air toward the basket.

12. The air fryer of claim 11, wherein the air deflector creates a conical shape around the coil element.

13. The air fryer of claim 12, where the fan assembly is arranged at least in part, external to the cavity.

14. The air fryer of claim 13, wherein at least one blade of the fan assembly is arranged within the cavity above the coil element.

15. The air fryer of claim 14, wherein the at least one blade is arranged within the air deflector.

16. The air fryer of claim 9, where the fan assembly creates a recirculation vortex by circulating air from inside the cavity.
